(19) United States
(12) Patent Application Publication
(10) Pub. No.: US 2010/0266817 A1
(43) Pub. Date: Oct. 21, 2010

(54) CERAMIC ARTICLE IMAGING PROCESS AND MATERIALS

(75) Inventor: Paul Hirst, Sheffield (GB)

Correspondence Address: B. CRAIG KILLOUGH, P. O. DRAWER H, CHARLESTON, SC, 29402, US

(73) Assignee: Octi Tech Limited, LLC, Mt. Pleasant, SC (US)

(21) Appl. No.: 12/760,768

(22) Filed: Apr. 15, 2010

Related U.S. Application Data
(60) Provisional application No. 61/169,530, filed on Apr. 15, 2009.
(60) Provisional application No. 61/236,333, filed on Aug. 24, 2009.

(51) Int. Cl. B32B 3/30; B32B 7/02; B32B 18/00

(52) U.S. Cl. 428/161; 428/156; 428/173

(57) ABSTRACT

A ceramic substrate has a robust and irregular hard surface. The ceramic substrate is imaged, with the image layer occupying lower areas or valleys. Higher areas or peaks valleys protect the image from mechanical forces to which the ceramic article is subjected after installation. A glaze may be applied over the ceramic substrate, with the glaze providing peaks and valleys, with the image layer in the valleys. The glaze may impart hardness for protecting the image layer from mechanical forces.

Applicant claims the benefit of the following U.S. Provisional Applications: U.S. Provisional Application Ser. No. 61/169,530 filed Apr. 15, 2009 and U.S. Provisional Application Ser. No. 61/236,333 filed Aug. 24, 2009.

### FIELD OF THE INVENTION

This invention relates to imaging processes, substrates for use with imaging processes, and imaged articles. More specifically, this invention relates to an imaging process for ceramic materials, ceramic substrates useful with the imaging process, and the resulting imaged ceramic article.

### BACKGROUND OF THE INVENTION

Ceramic materials have been used widely in building and decorative applications. Ceramics are hard and durable, and are easy to clean and maintain. Transparent, white and colored ceramic objects, such as tiles may be imaged. Suitable ceramic articles for imaging include wall tiles and floor tiles. Imaged ceramic objects not only increase the aesthetic appearance, but also enhance the value of these materials, especially when these images carry unique artistic designs.

Computer software allows printing or imaging of individual ceramic tiles or ceramic articles for subsequent assembly into a larger printed image. Wall, ceiling or floor murals can be constructed by assembly in order of individual ceramic tiles. Similarly, commercial logos or designs may be formed for use in building construction by assembly of individually imaged ceramic tiles.

However, such ceramic articles do not easily support and retain images with the degree of permanency that is desired for architectural use. Ceramic tiles and articles are very durable, but heretofore, images printed or formed on the ceramics are not durable, and tend to have low resistance to abrasion, scrapes, gouges, and similar mechanical forces. Walking on tiles, especially in commercial settings, and cleaning tiles with abrasive cleaners, will subject tiles to such mechanical forces during normal use. Placement of ceramic tiles is relatively expensive. Ceramic articles are not inexpensively replaces, and sometimes, are not easily replaced if the image becomes worn or fades.

Ceramic articles, especially glazed ceramic articles possess chemical and mechanical stability and durability, and are liquid resistant and weather resistant when surface glazed. However, the glass layer applied to the surface is highly inert to chemicals, and therefore, fixing permanent images on the surface is difficult unless a high temperature process is involved. The high temperature process may involve bringing the temperature above the softening or melting temperature of the glass layer, and the temperature may reach over 1000° C., which is extremely energy demanding, and may create safety concerns.

Imaging or printing methods such as silk screen printing, pad printing, and hot stamp printing are used in ceramic object imaging processes. High viscosity inks containing organic solvent or co-solvent and polymers such as PVC are printed on the surface of the object followed by drying and/or curing.

Lamination methods have been used for protecting imaged ceramic articles. Lamination overcomes problems associated with printing and ink jet printing due to the intrinsic lack of adhesion and bonding of inks to the surface of glazed ceramic substrates. One example is the use of thermosetting adhesives to laminate ceramic tiles. The laminate covers the majority to entirety of the surface of the ceramics. However, properties of the ceramic materials are negatively impacted. The advantages of the structural, chemical and mechanical properties of ceramics are limited by or replaced by the properties of laminating materials.

Similarly, imaged films have been applied to ceramic substrates. The coated film, due to its polymeric nature, suffers from similar limitations as lamination processes, such as low mechanical durability or softness, and poor longevity. These limitations are especially apparent when the image is exposed to various environmentally harsh conditions that are unfriendly to the polymeric materials. Sublimation dyes imaged on the surface of the film are also negatively impacted by environmentally harsh conditions, including radiation, such as ultraviolet, visible and infrared radiation, which eventually cause the fast fading of the image. Heretofore, images formed on ceramics with inks such as sublimation inks have had poor abrasion resistance

There is a need to create an imaged ceramic article, and an associated process, including a digital imaging process, which will overcome the shortcomings of imaged ceramic articles and processes previously known.

### SUMMARY OF THE PRESENT INVENTION

The present invention includes a ceramic substrate, and includes a process of producing the durable ceramic article that is suitable for various imaging applications. The imaged ceramic substrate according to the invention is mechanically and chemically stable. The process allows durable imaging of ceramics to produce decorative products using various imaging methods, including digital imaging processes, such as inkjet ink printing processes.

In one embodiment, the ceramic material has a glaze applied over a surface of the ceramic article. The glaze has an irregular, hard surface. An image is applied over the glaze, with the image occupying lower areas, or valleys, of the glaze. The higher spots, formed by the hard glaze, protect the image from mechanical forces to which the ceramic article is subjected. The ceramic material may also have a coating placed over the printed image to further protect the image.

### DESCRIPTION OF THE DRAWINGS

FIG. 1 is a partial, sectioned view of a glazed ceramic article according to the invention.

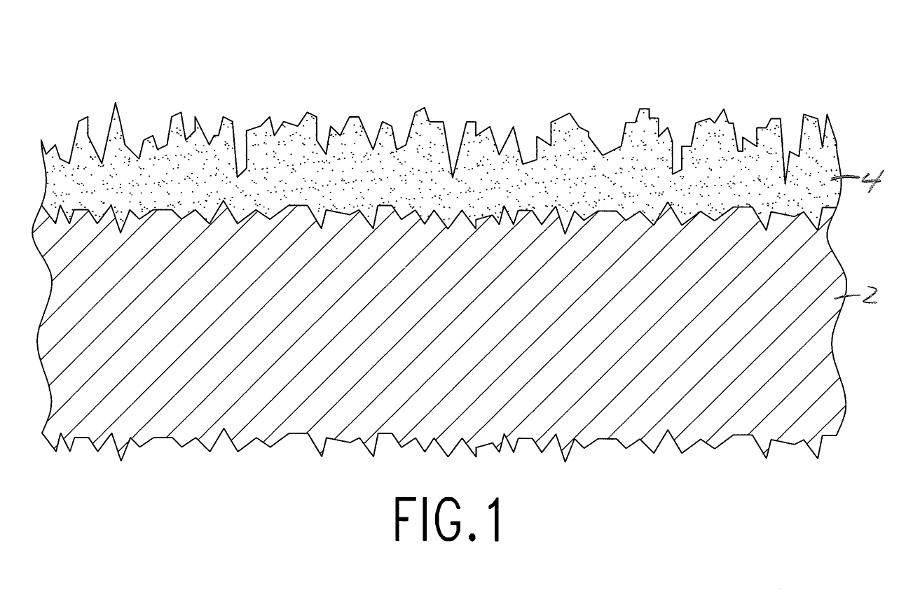

FIG. 2 is the glazed ceramic article of FIG. 1, demonstrating the surface irregularities of the glazing on the ceramic article.

FIG. 3 is the glazed ceramic article of FIG. 1, with an ink layer shown as printed on the ceramic article.

FIG. 4 is the glazed ceramic article of FIG. 3, with an optional protective coating shown as applied over the ink layer.

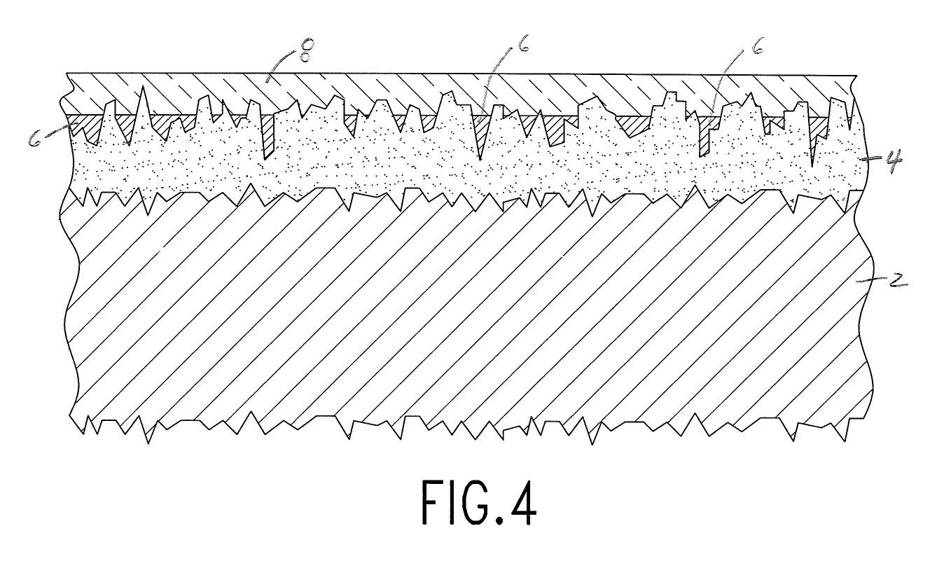

FIG. 5 is the glazed ceramic article of FIG. 1, with an ink layer shown as printed on an ink receptive layer.

FIG. 6 is a partial and enlarged view of glazed ceramic article taken as indicated from FIG. 5, with the ink layer shown as printed on the ink receptive layer.

### DETAILED DESCRIPTION OF PREFERRED EMBODIMENTS

In one embodiment, a ceramic article 2 is surface glazed with a glaze 4. The glaze may be a gloss, semi-gloss or matte glaze. The ceramic article comprises three-dimensional surface characteristics, as does the glaze, with surface variations of the glaze within limits that are suitable for imaging. The glazed and imaged ceramic article according to the invention has chemical and mechanical durability. The ceramic article, when imaged according to the invention, is suitable for decorative applications, such as floor or wall tile, general stoneware, domestic porcelain and the like.

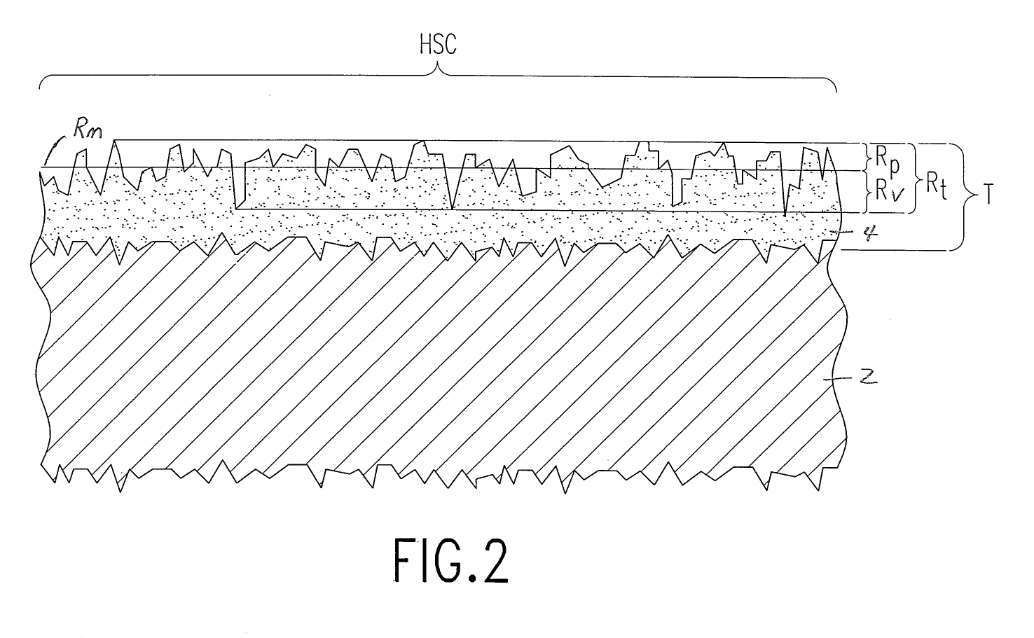

In an embodiment of the invention, a ceramic article such as a decorative tile has a substantially continuously glazed layer of thickness T applied over an unglazed base tile. FIG. 2. The glazed layer T has a randomized three dimensional variation of total thickness of Rₜ that is less than the thickness of the whole glazed layer. The height of the peaks (Rₚ) and the depth of the valleys (Rᵥ) do not conform to any repeating pattern in any direction across the glazed surface. Preferably, the total thickness of the glaze layer is between 25 microns and 2000 microns, and the randomized uneven layer Rₜ is between 5 microns and 200 microns.

In another embodiment, a ceramic article comprises three-dimensional surface characteristics and is not glazed with surface variations of the ceramic within limits that are suitable for imaging. The imaged ceramic article according to the invention has chemical and mechanical durability. The ceramic article, when imaged according to the invention, is suitable for decorative applications, such as floor or wall tile, general stoneware, domestic porcelain and the like. While this non-glazed embodiment is feasible, glazing is preferred to impart hardness to the peaks so as to protect the image layer.

The ceramic material used to form the substrate of the invention is preferred to have a sufficient density of peaks, defined by the parameter of High Spot Count (HSC). HSC is the number of peaks above the specified threshold. The threshold is relative to the mean plane of the surface. These peaks may be formed by ceramic and/or the glazed layer to achieve high mechanical and chemical durability of the glazed ceramic surface. FIG. 2. In an embodiment, the High Spot Count (HSC) is not less than 200 peaks per centimeter in all directions. In other words, it is preferred to have not less than two hundred peaks in any random direction of one centimeter in length on, and along, the surface of the ceramic glaze. The randomized three dimensional structures are suitable for receiving imaging materials such as liquid ink or toner. Enhanced mechanical and chemical properties of the imaged substrate can be achieved when imaging materials such as ink, toner, or coating layers are deposited between the peaks to form an image layer in what may be considered as the valleys, and over the glazed layer.

The ceramic substrate but before imaging, should have an average roughness (Ra) of not less than 7.5 Ra (microns). If the ceramic substrate is glazed, the glazing should produce a surface for imaging having an average roughness (Ra) of not less than 7.5 Ra (microns). After the ceramic material substrate is imaged, the ceramic substrate should have an Ra of not less than 5.0 microns. This measurement assumes that no coating is present over the image layer. The resulting ceramic substrate may have an Ra of less than 5.0, and less than 1.0 microns, if the ceramic material is coated after imaging.

| Ceramic | | | | | |
|---|---|---|---|---|---|
| Substrate | Rp | Rv | Rz | Rt | Ra |
| Unprinted | 56.17 | 27.484 | 83.654 | 83.654 | 17.148 |
| Printed 1 | 37.347 | 14.615 | 51.962 | 51.962 | 7.558 |
| Printed 2 | 34.337 | 21.362 | 55.699 | 55.699 | 11.292 |
| Printed 3 | 34.995 | 18.96 | 53.954 | 53.954 | 8.978 |
| Printed 4 | 30.311 | 18.224 | 48.535 | 48.535 | 9.089 |

Ra is Arithmetic Average Roughness, which generally reflects the average height of roughness component irregularities from a mean line.
Rp is the Maximum Peak Height.
Rv is the Maximum Valley Depth.
Rp + Rv equals Rt. In each specimen, Rt and Rz are the same.
Rz is the Mean Roughness Depth, which is the average distance between the highest peak and the deepest valley.
The values are in microns.

The table above compares roughness values for a ceramic substrate in the form of an unprinted tile with the same tile structure printed with four different inks. The unprinted tile is glazed, but uncoated, and is suitable for use as an imaged substrate according to the invention. It has an irregular surface, and an Ra of 17.15 microns. When the tile substrate is imaged with an inkjet ink comprising a sublimation dye to form an image layer, the Ra is reduced to 11.29 to 7.56 microns, depending on the ink and the printing process. See the Printed 1-4 values in the table. The measurements herein were taken by Olympus® LEXT OLS4000 laser confocal microscope, which uses a laser to measure the surface properties of the ceramic material.

In each of the examples in the table above, the ceramic material substrate is not coated, that is, no coating is applied over the image layer prior to taking the roughness measurement. The Ra may be reduced to below 1.0 microns, or higher if desired, by coating the ceramic substrate. The image layer's susceptibility to mechanical disruption is decreased by surface roughness. If the image lawyer is overcoated, the overcoating may be susceptible to mechanical disruption, but the overcoating further protects the image.

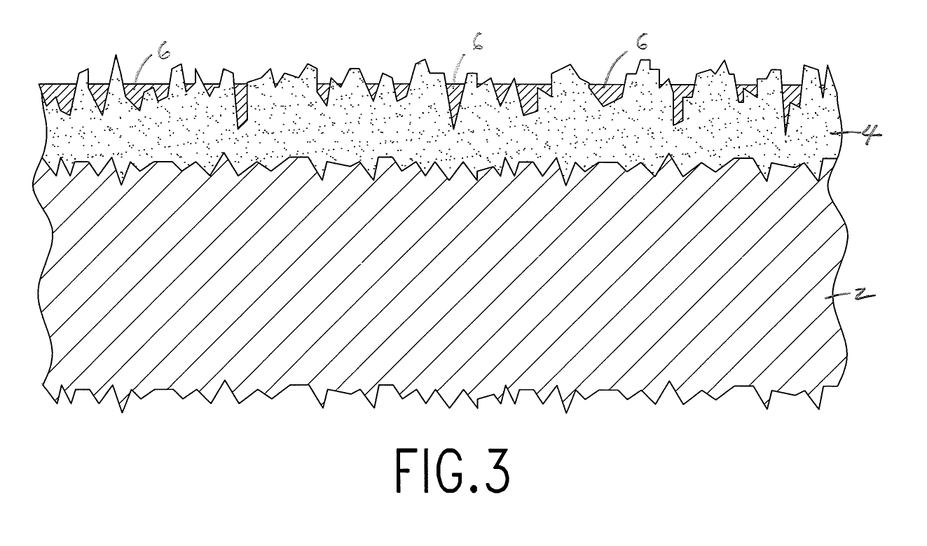

It is preferred that the image layer 6 not extend above a material number of the higher peaks as shown in FIG. 3. After imaging, the resulting High Spot Count (HSC) is preferred to be not less than 100. The peaks protect the image layer from mechanical forces such as abrasion. In one embodiment, the ink layer is applied in the valleys and below the peaks and to a height that is not substantially above the height of Rm, which is the mean average distance between the peaks and the valleys.

In a preferred embodiment, the glaze layer 4 is light colored, or generally white. The glaze may be transparent or translucent, and suitable for receiving a light colored image without materially obscuring or materially impacting the clarity of the image. The resulting glaze must be sufficiently hard to provide the resistance to mechanical forces required by the application, so as to protect the image that is formed on the substrate. Preferably, the surface of the glaze has a hardness of higher than 4 on the Mohs scale, and more preferably, a minimum hardness of between 5 and 8 on the Mohs scale.

The image layer is shown as level in the drawings. While it is preferred to have the image layer level and consistent, in practice, the top surface of the image layer may vary in height from one valley to another. The image layer should be consistent enough to present the desired visual image by the image layer.

The glaze layer is substantially free of lead, chromium, mercury, or other heavy metals that comprise environmentally hazardous or toxic materials.

Embodiments of methods of creating the glaze layer include an ‘additive method’ and a ‘subtractive method’. The first method comprises forming a glaze layer on the unglazed ceramic base through glaze firing methods in a high temperature oven or kiln, which may be an electric kiln. By adjusting the glaze layer material composition and firing parameters, the final glazed surface with the randomized three dimensional characteristics can be achieved. The resulting article is highly receptive of imaging processes according to the invention.

A general composition used for the glazing composition may comprise feldspar, kaolinite, refractory materials and suspension materials. One or more flux materials, glass-formers, and stabilizing agents may also be added. A preferred starting composition has feldspar materials that soften at about 700° C., and melt at temperature about 1000° to 1500° C.

The ceramic glaze may comprise aluminosilicate based feldspar glass composition, although other feldspar glass compositions may be used. Feldspar has a Mohs hardness of about 6, and yields a hard glaze that is suitable for many applications. Orthoclase, albite, or anorthite may be used in different percentages to achieve specific thermal, mechanical and optical property needs, with varying amounts of other additives such as opacifier, colorant/stainer, metallic powder, glass frits, and/or polymeric materials. Examples of these glaze compositions include SiO₂—Al₂O₃—CaO, ZrSiO₄—Al₂O₃—CaO, SiO₂—Al₂O₃—B₂O₃—CaO, SiO₂—Al₂O₃—BaO—CaO, SiO₂—Al₂O₃—BaO—CaO and the like as the backbone ingredients.

At least one high temperature refractory material, which is a heat resistant material, is preferred to be used in the glaze composition, wherein the softening and melting temperature is at least 100° C. higher than the softening and melting temperatures of feldspar materials. The high temperature refractory material may be transparent or translucent in color, with a preferred hardness of not less than 5 on the Mohs scale. The resulting material is preferred to be chemically stable and alkaline and acid-resistant. The refractory material is preferred to be compatible with the remainder of the ingredients of the glaze composition. The melting temperature may be influenced by the flux material used in the composition. Suitable flux materials include Na₂O, K₂O, CaO, ZnO, barium carbonate, bone ash, borax, gerstley borate, colemanite, magnesium carbonate, talc, dolomite, whiting, or combinations.

The particle size and particle distribution profile of the refractory material or materials in the starting glaze composition will impact the surface characteristics of the ceramic article for the present invention. It is preferred that the particle sizes of the material are not less than 20 microns but not greater than 200 microns, and more preferably, the particles should fall within a range between 50 to 150 microns. To achieve the preferred evenly distributed three-dimensional randomized structures, a normal distribution in particle size is most desirable. In addition, it is preferred that the high temperature refractory material has a lower thermal expansion coefficient than a feldspar and/or the feldspathic glass matrix, when temperatures are above ambient temperature. This property not only helps the mechanical stability of the ceramic material prior to imaging the surface, but also helps the stability and durability of the imaged ceramic material. The relatively low thermal expansion coefficient (CTE) allows for little distortion or displacement with temperature changes. The high temperature refractor may be a crystalline or amorphous material. Examples include quartz, alumina, zirconia, silicon nitride, silicon carbide, aluminosilicate and/or sintered aluminosliicate such as andalusite, kyanite, sillimanite, and mullite, spinel, clay and cacined clay or chamotte, anacime, gismondine, cordierite, and anorthite.

Various zeolites may also be used to increase the surface properties. Zeolites are intrinsically porous and alkaline-resistant. Zeolites are self-nucleating and develop micro-crystalline structures that may be employed in the glassy glaze layer, lending improved mechanical properties. Suitable zeolites include harmotome, phillipsite, zeolite B, zeolite ZK-19, zeolite W, zeolite X, and zeolite Y. These zeolites may be used alone, or in combination. They may also be used with kaolinite in the glaze composition.

The base ceramic for the ceramic article to be glazed and imaged may be formed of known ceramic materials, including various types of bisque ware, unglazed or glazed stoneware, earthware or porcelains. Natural stone, cast stone, concrete or glass may also be used as the base ceramic material for the present invention. It is preferred that the base ceramic be substantially homogeneous in composition with suitable mechanical/dimensional, thermal and chemical stability, so as to support the glazing treatment and utility of the ceramic material. Minimal, or no, deformation through the glaze firing process is desirable. Various combinations of clay, kaolinite (calcined kaolinite), feldspar (potassium, sodium, lithium, magnesium etc.) with other ingredients may be used to form the base ceramic article.

The glaze composition may be prepared by pre-mixing the composition with a flocculent, and/or suspending agent combined with a carrier such as water, glycol, diethylene glycol or polypropylene glycol, etc., or a combination thereof, to prevent settling and to produce thoroughly mixed and/or dispersed ingredients, especially those ingredients having high specific gravity. Common examples of mineral or inorganic flocculents or suspending agents include CaCl2, attapulgite clay, smectite clay, and the like. Different types of organic dispersants may also be used to create a suitable suspension. Thickening agents or viscosity modifiers such as carboxymethylcellulose (CMC), hydroxyethylcellulose (HEC), Xantham gum, polyacrylamide, polyethylene oxide (PEO), polyvinyl alcohol (PVA), polyvinyl pyridine (PVP) or the like may also be used. Other materials such as surface active agents, wetting agents, pseudoplastic liquid modifiers, and/or whitening materials may also be used in the mixture. The glaze composition may then be applied by any suitable method, such as coating, brushing, spraying, dipping, or transferring, as long as the glaze material is applied in sufficient thickness and is evenly distributed. The total solid to liquid ratio of the glaze composition may be adjusted based on the application method and the final glaze layer thickness. A preferred range of the wet glaze composition layer is from 50 microns to several millimeters prior to firing.

The glaze firing temperature may range from 800° C. to 1300° C., depending on the material to be fired. A programmed temperature gradient may be used for pre-heating, firing, and cooling. The heating and cooling pattern will ensure the generation of the required surface characteristics of the glaze surface by melting, and/or partially melting, the high temperature refractory materials, so that a continuous glassy glaze is formed. For example, a short period of time may be employed and maintained to dry the applied glaze material, followed by high temperature firing to form the glaze. Slow cooling for preferably no less than 2 to 3 hours may be used to retard thermal shock of the glass glaze and create an increased quantity of microcrystals in the glaze structure, thereby improving chemical and mechanical durability. When using the ‘additive method’ in producing the glaze layer, temperature control is important so that the high temperature refractory materials do not melt completely, which would tend to reduce, and perhaps eliminate, the desired surface unevenness.

In one embodiment, a ‘subtractive method’ of preparing the material is employed. Different physical and/or chemical means may be used to create the randomized three dimensional structures on smooth ceramic material, such as a previously glazed smooth ceramic. High temperature laser or plasma sputtering, chemical etching, mechanical impacting, masked chemical vapor deposition, etc., are suitable to reform the surface according to the ‘subtractive method’.

The present invention may be used with either or both direct imaging or transfer imaging processes. Conventional printing methods, such as offset, silk screen, letterpress, lithographic, gravure, or varnishing may be used for creating an image directly on the ceramic article. Digital printing methods such as inkjet (for example, either thermal/bubble or piezo drop-on-demand inkjet, continuous inkjet), thermal transfer, and electrophotographic printing may also be used to image and/or decorate the ceramic article. Different colors of inks, primer inks, undercoat and/or overcoat inks may be applied through multiple channels of a digitally driven ink jet printer during a single imaging process without switching to another printer. The combination of both conventional printing/coating and digital printing may also be employed to as required achieve the best image outcome on the ceramic article.

The preferred ink or imaging materials are those capable of forming a composite structure with the glazed surface. In addition to colorants, film forming binder, polymers of either natural or synthetic, energy or radiation curable resins, crosslinkable or reactive constituents, sol-gel or aerogel components or systems may be used to form a desired composite imaging matrix. These materials may be applied to the substrate via various aqueous, solvent, oil, hot melt or polymeric/oligomer-prepolymer combinations. Metal ion colorant ink, toner or thermal transfer ribbon hot melt materials are also suitable for the ceramic article imaging process. At least one portion of the imaging material should be applied within the randomized three dimensional structures (within Rₜ).

An optional overcoat layer 8 may be printed or coated over the image. Preferably, the overcoat layer is transparent or substantially transparent to allow the image to be clearly seen, but the overcoat layer may be translucent, letting light pass through to the image. The overcoat layer may be used to form a smooth outer surface having a roughness Ra of less than 1.0 microns. If desired, a thinner overcoat layer may allow some of the peaks to extend above the overcoat layer and the roughness Ra may be greater than 1.0 microns. The overcoat layer may be subject to wear, abrasion, gouging and other mechanical forces, but will add further protection to the image layer.

The ceramic material forming the substrate may be imaged by transfer printing. Dye sublimation transfer printing, decal transfer, and transfer paper applications may be used. The surface characteristics of the ceramic substrate described herein provide enhanced durability and abrasion resistance.

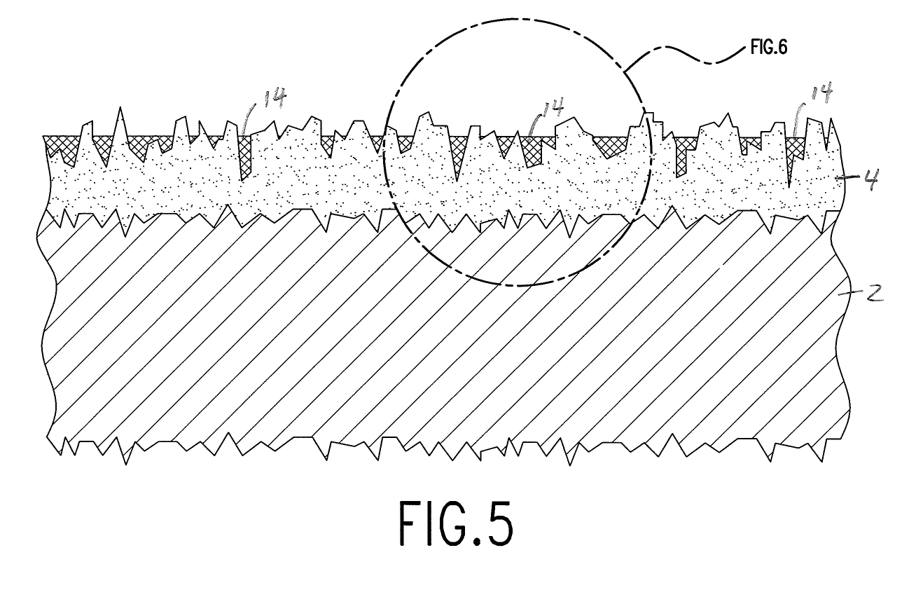

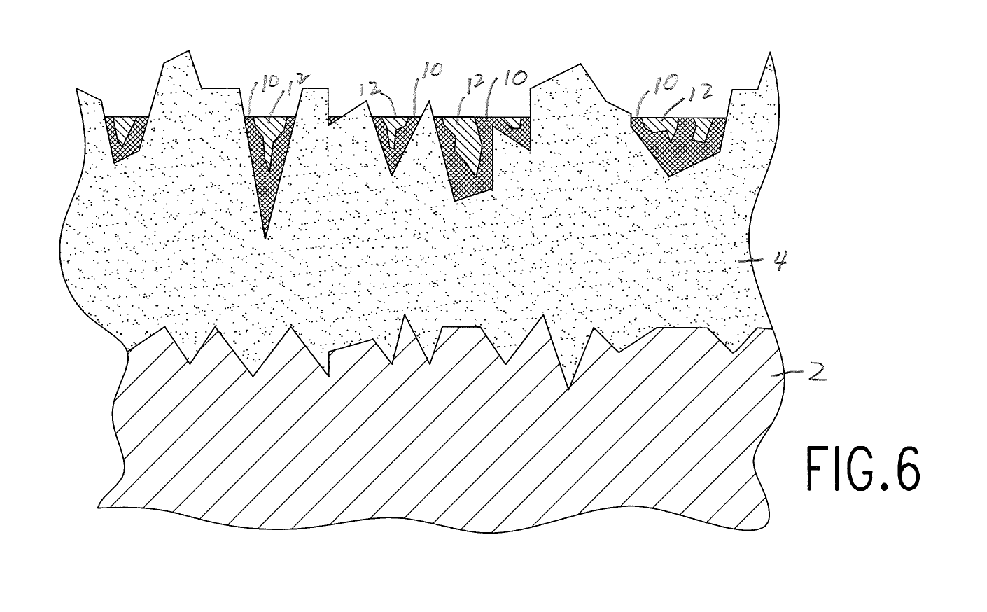

In one embodiment as depicted in FIG. 5 and FIG. 6, an ink receptive layer 10 is either printed or coated first with the glaze layer 4 and the ceramic material having the three dimensional structures. Thermally transferred ink 12 in a desired image is applied to the structural matrix, forming image layer 14 within the valleys and below the peaks of the rough surface of the ceramic substrate. In most embodiments, it is preferred that the upper surface of the image layer is at, or below, the mean line Rm. The imaging material and process of imaging will impact the actual portion of the surface of the image layer relative to the mean line.

In an embodiment similar to the one shown in FIG. 5, an ink comprising heat activated dye, such as sublimation dye is used. The image may be directly printed or transferred onto the ceramic substrate. An ink receptive layer for sublimation applications may be applied to the ceramic substrate, and if glazed, over the glaze layer. The ink receptive layer may comprise synthetic polymeric materials such as ester, polyurethane, polyamide, epoxy-polyester or similar polymer materials as components. The ink comprising sublimation dye will have an affinity for these ink receptive materials of the ink receptive layer, but not for the glaze, if the ceramic substrate is glazed. The sublimation dye will bind to the polymeric ink receptive material in the valleys of the ceramic, and will be protected by the peaks of the ceramic and/or the glaze from mechanical forces such as abrasion.

By selecting an appropriate composition of the glaze materials, including glass forming, flux, refractory and high melting temperature particulates, the present invention allows creation of a durable glazed surface of ceramic articles having an evenly glazed surface with a three dimensionally randomized microstructure that allows the ceramic glaze surface to form a durable composite image upon applying an image layer formed of color inks or toners.

The current invention further provides an imaging method by forming a composite structure on the glazed ceramic tile without a second high temperature firing process or pre-conditioned coating/printing. The present invention further provides an imaging process on the mentioned ceramic article that may be used with both direct printing and transfer printing, including heat sensitive ink imaging.

What is claimed is:

1. An image receiving ceramic substrate, comprising:
a ceramic substrate comprising an irregular surface, said irregular surface comprising a plurality of image receiving valleys formed between a plurality of peaks, wherein an image layer is formed within said valleys and below said peaks of said irregular surface to form an imaged surface of the ceramic substrate, and wherein the imaged surface has an average roughness (Ra) of not less than 5.0 microns when measured without a coating present over said image layer.

2. An image receiving ceramic substrate, comprising:
a ceramic substrate comprising an irregular surface,
a glaze formed over the irregular surface of the ceramic substrate, the glaze comprising an irregular surface formed on the irregular surface of the ceramic substrate, the irregular surface of the glaze comprising a plurality of image receiving valleys formed between a plurality of peaks, wherein an image layer is formed within said valleys and below said peaks of said irregular surface of the glaze to form an imaged surface of the ceramic substrate, wherein the imaged surface has an average roughness (Ra) of not less than 5.0 microns when measured without a coating present over said image layer.

3. The image receiving ceramic substrate of claim 2, wherein the glaze has a Mohs hardness of not less than 4.0.

4. The image receiving ceramic substrate of claim 2, wherein the glaze has a Mohs hardness within a range of 5.0 to 8.0.

5. The image receiving ceramic substrate of claim 1, wherein a coating is placed over the imaged surface, and wherein the coating allows light to pass through the coating to the image layer.

6. The image receiving ceramic substrate of claim 2, wherein a coating is placed over the imaged surface, and wherein the coating allows light to pass through the coating to the image layer.

7. The image receiving ceramic substrate of claim 1, wherein a coating is placed over the imaged surface, and wherein the coating is substantially transparent.

8. The image receiving ceramic substrate of claim 2, wherein a coating is placed over the imaged surface, and wherein the coating is substantially transparent.

9. The image receiving ceramic substrate of claim 2, wherein the image layer is formed with an ink comprising sublimation dye.

10. The image receiving ceramic substrate of claim 2, wherein a polymer is present over the glaze, and the image layer is formed over the polymer with an ink comprising sublimation dye.

11. The image receiving ceramic substrate of claim 2, wherein the glaze allows light to pass though to the ceramic material, and a polymer is present over the glaze, and the image layer is formed over the polymer with an ink comprising sublimation dye, and wherein light is reflected from the ceramic material through the sublimation dye, the polymer and the glaze.

12. The image receiving ceramic substrate of claim 1, wherein the irregular surface of the ceramic substrate prior to application of the image layer has a High Spot Count of not less than 200 per centimeter.

13. The image receiving ceramic substrate of claim 2, wherein the irregular surface of the glaze prior to application of the image layer has a High Spot Count of not less than 200 per centimeter.

14. The image receiving ceramic substrate of claim 2, wherein the glaze comprises a refractory material that is not completely melted during a glaze firing process.

15. The image receiving ceramic substrate of claim 2, wherein the glaze material is not completely melted during a glaze firing process.

16. The image receiving ceramic substrate of claim 2, wherein the glaze comprises a refractory material in a particulate form that is not completely melted during a glaze firing process.

17. The image receiving ceramic substrate of claim 1, wherein substantially the entire top surface of the image layer is below a mean line Rm of the top surface of the ceramic substrate.

18. The image receiving ceramic substrate of claim 2, wherein substantially the entire top surface of the image layer is below a mean line Rm of the top surface of the glaze of the ceramic substrate.
